(19) United States
(12) Patent Application Publication
(10) Pub. No.: US 2002/0178448 A1
(43) Pub. Date: Nov. 28, 2002

(54) Method and system for registering a user preference

(76) Inventors: Jan Benjamin Te Kiefte, Eindhoven (NL); Duco Annardo David Das, Eindhoven (NL); Eibert Van De Streek, Eindhoven (NL)

Correspondence Address: U.S. Philips Corporation, 580 White Plains Road, Tarrytown, NY, 10591, US

(21) Appl. No.: 10/118,874

(22) Filed: Apr. 9, 2002

(30) Foreign Application Priority Data
Apr. 12, 2001 (EP) 01201345.4

(51) Int. Cl. H04N 5/445

(52) U.S. Cl. 725/46

(57) ABSTRACT

A method and system for registering a user preference for a program (201) in at least one of a collection (221) of preference profiles for recording a set of user preferences. An input (211, 212) representing the user preference for the program (201) is received. For each preference profile from said collection (221) a score for the program (201) is determined, said score indicating the degree of agreement of the program (201) with said preference profile.

If the input (211, 212) represents a positive user preference, a preference profile having a relatively high score, preferably the maximum score, is updated to reflect the positive user preference for the program (201). Otherwise a preference profile from said collection (221) having a relatively low score is updated.

The invention relates to a method of registering a user preference for a program in at least one of a collection of preference profiles for recording a set of user preferences.

The invention further relates to a system for registering a user preference for a program in at least one of a collection of preference profiles for recording a set of user preferences.

As the number of channels available to television viewers has increased, along with the diversity of the programming content available on such channels, it has become increasingly challenging for television viewers to identify television programs of interest. Historically, television viewers identified television programs of interest by analyzing printed television program guides. Typically, such printed television program guides contained grids listing the available television programs by time and date, channel and title. As the number of television programs has increased, it has become increasingly difficult to effectively identify desirable television programs using such printed guides.

More recently, television program guides have become available in an electronic format, often referred to as electronic program guides (EPGs). Like printed television program guides, EPGs contain grids listing the available television programs by time and date, channel and title. Some EPGs, however, allow television viewers to sort or search the available television programs in accordance with personalized preferences. In addition, EPGs allow for on-screen presentation of the available television programs. While EPGs allow viewers to identify desirable programs more efficiently than conventional printed guides, they suffer from a number of limitations, which if overcome, could further enhance the ability of viewers to identify desirable programs. For example, many viewers have a particular preference towards, or bias against, certain categories of programming, such as action-based programs or sports programming. Thus, the viewer preferences can be applied to the EPG to obtain a set of recommended programs that may be of interest to a particular viewer.

Thus, a number of tools have been proposed or suggested for recommending television programming. The TiVo™ system, for example, commercially available from TiVo, Inc., of Sunnyvale, Calif., allows viewers to rate shows using a “Thumbs Up and Thumbs Down” feature and thereby indicate programs that the viewer likes and dislikes, respectively. Thereafter, the TiVo receiver matches the recorded viewer preferences with received program data, such as an EPG, to make recommendations tailored to each viewer.

The user interface in the known method and system has the feature of keeping record of preferences and interests of a user. This kind of interest can be stored in a so-called preference profile for that user. A preference profile comprises metadata with several attributes, which can have values indicating the user's interest, lifestyle, favorite program categories, actors, movies, and so on. These attributes can be rated by the user, for example by giving a value of 1 to 5 for each. A value of 5 would indicate the user very much likes the attribute in question, and a value of 1 that he does not like it at all.

A program has descriptive data, indicating things like its title, its category, the actors in it, and so on. This descriptive data can be compared against the attributes in the preference profile, and a score indicating the degree of agreement of the program with the preference profile can be determined.

A score could be, for instance, the (weighted) sum of all the values assigned to attributes in the preference profile that are also present in the descriptive data of the program. For example, if the user has assigned a value of 5 to the attribute representing program category ‘science fiction’, then the score for a program in the category ‘science fiction’ would be increased by five. Alternatively, a technique such as a Bayesian classifier can be used to compute the probability that a program is a desirable one, given a preference profile. This probability can be seen as the score of the program. Many other techniques for determining a score indicating the degree of agreement of the program with the preference profile are known in the art and can be used as well here.

When the user indicates his like or dislike of a particular program, the preference profile is updated to reflect this new information. For example, if the indicates he likes a particular actor, an attribute representing that actor's name is added to the preference profile with a positive rating. Any subsequent determination of a score for a program will then be positively influenced if that actor participates in that program.

The known system may allow the user to maintain multiple preference profiles. Multiple users share the same television environment, and it is desirable that their respective preferences are not mixed into one single preference profile. Further, one user may want to maintain different preference profiles for different television program categories like sports, news, soaps, science fiction and more. It is expected that over time there will be more refined preference profiles. Examples may include preference profiles for baseball, Larry King, Friends and Star Trek, or even more specific ones. The user can then simply access his “baseball” profile and view only baseball-related items, or access his “comedy” profile and view only humorous items. If all the user's preferences and interests were recorded in a single preference profile, baseball-related items and humorous items would both be presented for selection by the user. This conflicts with the user's expectations, since when he wants to see baseball, he does not want to be confronted with sitcoms or funny movies.

When the user now indicates his like or dislike of a particular program, it is not immediately evident in which preference profile this like or dislike should be recorded. The most simple approach is to record the like or dislike with the most recently used preference profile. Alternatively, the user can be asked to select a preference profile, either at the moment of indicating his like or dislike, or beforehand, i.e. in some kind of “log in” procedure. However, any explicit selection of the preference profile by the user when expressing likes or dislikes is a too complex proposition in a television context and is not compatible with the concept of implicit preference recording. The user should be able to simply press “Thumbs up” or “Thumbs down” without any further interaction and have his preference recorded correctly.

It is an object of the invention to provide a method according to the preamble, in which the interaction with the user is minimized.

This object is achieved according to the invention in a method comprising

receiving an input representing the user preference for the program,

determining for each preference profile from said collection a score for the program, said score indicating the degree of agreement of the program with said preference profile,

if the input represents a positive user preference, updating a preference profile from said collection having a relatively high score with respect to the scores of all the preference profiles from said collection to reflect the positive user preference for the program, and

if the input represents a negative user preference, updating a preference profile from said collection having a relatively low score with respect to the scores of all the preference profiles from said collection to reflect the negative user preference for the program.

One program will have different degrees of agreement with different preference profiles. If the user indicates that he likes the program, this preference should be registered with the preference profile to which the program in question is best suited. This is a preference profile for which the program has a relatively high score. In the same fashion, if the user indicates his dislike for a particular program, this negative user preference should be recorded with the preference profile that is best suited for it. This is a preference profile having a relatively low score, indicating that, according to this preference profile, the user does not like this program.

There may be situations in which the preference profile to be updated differs from the preference profile having the relatively high score. For example, if the user has previously selected a particular preference profile, then that profile should of course be updated.

In an embodiment said relatively high score is a maximum of the scores of all the preference profiles from said collection, and said relatively low score is a minimum of the scores of all the preference profiles from said collection. By updating only the preference profile that has the highest respectively the lowest score of all the preference profiles, it is ensured that only the best matching profiles are updated. Of course, if two or more preference profiles each have a maximum score, then all of them should be updated.

In a further embodiment the received input is a numeric value, which is deemed to represent a positive user preference is the numeric value exceeds a threshold value, and which is deemed to represent a negative user preference otherwise. While it is often preferred to keep the rating system as simple as possible, it is in some cases desirable to allow the user to rating programs or attributes using a numeric value, for example on a scale from 1 to 10. In such case, the rating given by the user must be translated to either a positive or a negative user preference. By choosing a threshold value in advance, this determination can be made very easily.

In a further embodiment the preference profile is additionally updated to reflect the numeric value of the user preference. When using numeric ratings, more detailed information on the user's preference is obtained. This information should of course be recorded.

In a further embodiment, if plural preference profiles from said collection have the same relatively high score with respect to the scores of all the preference profiles from said collection, all said plural preference profiles are updated to reflect the positive user preference for the program. If two or more preference profiles appear to match equally well, than the program in question apparently is well-suited for both. This information should then be recorded in both preference profile.

In a further embodiment, if plural preference profiles from said collection have the same relatively low score with respect to the scores of all the preference profiles from said collection, all said plural preference profiles are updated to reflect the negative user preference for the program. In a similar fashion, an equally low score for plural preference profiles should be recorded in those plural profiles as well.

In a further embodiment, the method further comprises maintaining, for each preference profile from said collection, a personal channel for reproducing programs that match the preference profile to which the personal channel corresponds, and adding the program to the personal channel corresponding to the preference profile from said collection having the relatively high score. The concept of virtual channels by itself is known from International Patent Application WO 00/40012 (Attorney Docket PHN 17268). A personal channel is a collection of TV programs including recorded programs that match to a high degree with the preference profile associated with the personal channel, future programs that match to a high degree with the preference profile, and future TV programs that match to a lesser high degree, but that are still assumed to be of interest. The user can switch to the personal channel and then view only the programs that match the associated preference profile. When a positive rating for the program is added to a preference profile, this program apparently matches to a high degree with the preference profile in question. Therefore, the program should be added to the personal channel.

When the program that the user provided a rating for was selected from a personal channel, then it may be advantageous to update the preference profile associated with that personal channel, rather than the preference profile with the relatively high score, since in that case it is clear which preference profile the user is using to view programs.

It is a further object of the invention to provide a system according to the preamble, which requires a minimum of interaction with the user.

This object is achieved according to the invention in a system comprising

receiving means for receiving an input representing the user preference for the program,

scoring means for determining for each preference profile from said collection a score for the program, said score indicating the degree of agreement of the program with said preference profile, and

updating means for determining if the input represents a positive user preference, and if so updating a preference profile from said collection having a relatively high score with respect to the scores of all the preference profiles from said collection to reflect the positive user preference for the program, and if the input represents a negative user preference, updating a preference profile from said collection having a relatively low score with respect to the scores of all the preference profiles from said collection to reflect the negative user preference for the program.

In an embodiment the system further comprises personal channel means for maintaining, for each preference profile from said collection, a personal channel for reproducing programs that match the preference profile to which the personal channel corresponds, and adding the program to the personal channel corresponding to the preference profile from said collection having the relatively high score.

In a further embodiment the system further comprises a display for rendering the program. By realizing the system according to the invention as a television receiver, it is achieved that the user can rate the programs as he watches them or while browsing through the EPG before or after watching programs.

The invention further relates to a computer program product enabling a programmable device to function as a system according to the invention.

These and other aspects of the invention will be apparent from and elucidated with reference to the embodiments shown in the drawing, in which:

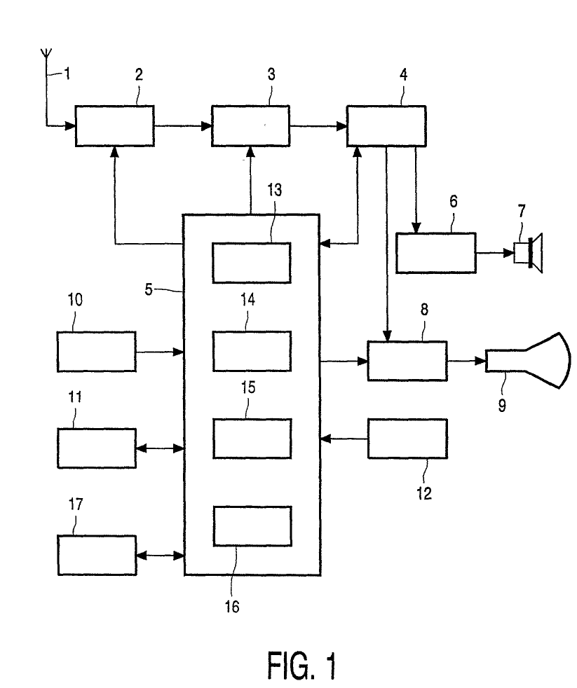

FIG. 1 schematically shows a television receiver comprising a system according to the invention;

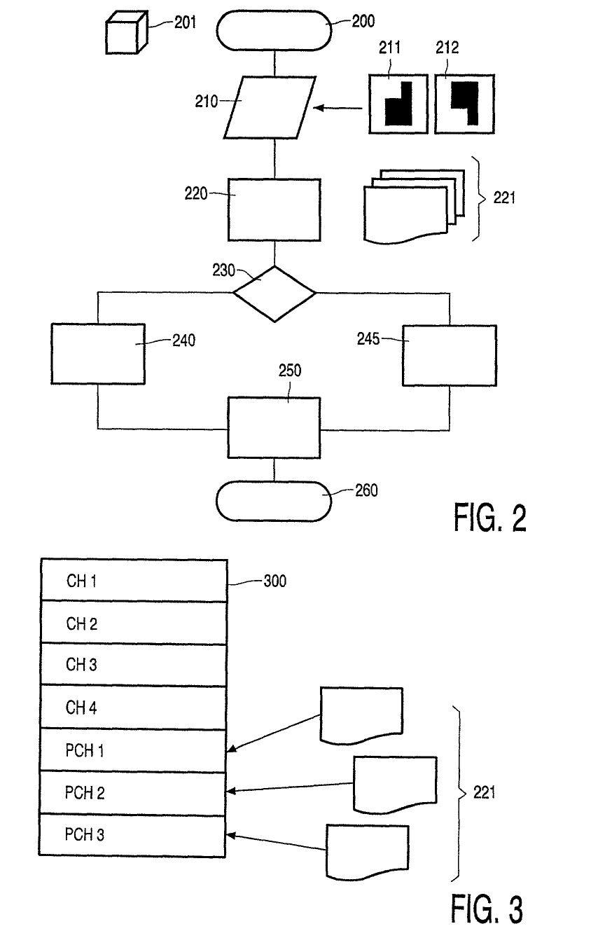

FIG. 2 is a flowchart describing an embodiment of the method of registering a user preference in accordance with the invention; and

FIG. 3 schematically illustrates the concept of personal channels.

Throughout the figures, same reference numerals indicate similar or corresponding features. Some of the features indicated in the drawings are typically implemented in software, and as such represent software entities, such as software modules or objects.

FIG. 1 schematically shows a television receiver comprising a system according to the invention. Digital broadcast streams, modulated upon radio frequency (RF) signals, are received from the ether by an antenna 1, or, alternatively, from a cable network. The broadcast streams may be formatted, for example, in accordance with the Digital Video Broadcasting (DVB) standard. A tuner 2 comprises a standard analog RF receiving device which is capable of receiving said RF signals and selecting one of them to be output to a demodulator 3. Which signal the tuner 2 is depending upon control data received from a central processing unit (CPU) 5. The demodulator 3 converts the analog signal into a digital packet stream, based on the control signals received from the CPU 5. This packet stream is then output to a demultiplexer 4, which selects packets belonging to a particular program in accordance with control data received from the CPU 5, and decomposes the packet stream into elementary audio, video or data streams.

In addition to broadcast signals, the television receiver may be adapted to receive signals from other sources too, for example, from a (digital) video recorder or DVD player, from the internet, or from a digital subscriber line. Programs and program attributes need not be obtained from the same source. For example, attribute and attribute values relating to broadcast programs may be obtained from an internet site.

A video processor 8 decodes the video stream received from the demultiplexer 4 or from the CPU 5. Decoded video data is then transmitted to a display screen 9. An audio processor 6 decodes the audio stream received from the demultiplexer 4. Decoded audio data is then transmitted to a speaker system 7.

The demultiplexer 4 outputs the elementary data stream to the CPU 5. The elementary data stream has two types of data: control data and content data. Content refers to, for example, interactive programs; control refers to tables in the multiplex which specify matters like the structure of the multiplex, the (RF) frequencies at which the channels are modulated, and the addresses at which the various content components and the (other) tables in the multiplex can be found. The CPU 5 comprises one or more microprocessors capable of executing program instructions stored in a read-only memory (ROM) 12. Alternatively, program instructions may be stored in a random-access memory such as a hard disk. These program instructions comprise parts of software modules including, inter alia, a command module 13, and a preference profile module 14. Data processed by said software modules, e.g. DVB-SI data and preference profile information, may be stored in a non-volatile memory 11. The command module 13 is capable of controlling functions of the television receiver, like tuning and demultiplexing a selection, and transmitting data to the video processor 8 to be presented on the screen 9.

A user command unit 10 receives user commands, e.g. through a remote control (not shown), and transmits them to the command module 13 to be processed. For example, when the user enters a channel number, the command module 13 controls the tuner 2 and the demultiplexer 4 to select the corresponding broadcast stream and data packets therein, and sends graphical data to the video processor 8 to present feedback on the screen 9, e.g. the present number, the channel name being displayed for a few seconds.

The preference profile module 14 interprets the program attributes, for example received as DVB-SI data from the demultiplexer 4 to collect information about the channels, or “services” in DVB terminology, which are available in the received broadcast streams and about the programs, or “events” in DVB terminology, which are scheduled for those channels. The preference profile module 14 may be arranged to learn from the user's viewing behavior. For example, the preference profile module 14 could receive the commands from the command module 13 and determine from that which programs the user finds interesting. The preference profile module 14 records the user's preferences and interest in a preference profile for a user. The preference profile module 14 maintains a collection of preference profiles.

A personal channel module 15 maintains for each preference profile from said collection, a personal channel for reproducing programs that match the preference profile to which the personal channel corresponds. The workings of this module 15 will become apparent with reference to FIG. 3.

FIG. 2 is a flowchart describing an embodiment of the method of registering a user preference in accordance with the invention. The method starts at 200. It may be necessary to perform some kind of initialization, for example by reading the preference profiles from a storage medium, loading the relevant software modules into memory, and so on. The user then interacts with a system in the conventional manner. When he encounters a program 201 for which he wishes to express a like or dislike, he activates a “thumbs up” button 211 or a “thumbs down” button 212 on his remote control.

Of course, other ways to allow a user to indicate his like or dislike for a particular program 201 also exists. For example, the user could enter a rating ranging from e.g. 1 to 10 or from 1 to 5, or by choosing one of plural possible ratings such as “very bad”, “bad”, “neutral”, “good”, and “very good”. Using a simple good/bad mechanism to indicate a preference has the advantage that it is very simple and intuitive.

Alternatively to registering the pressing of a button on a remote control, other ways to receive input from a user also exist. For example, the user could choose a menu option, select an on-screen display element, issue a voice command or perform a specific gesture.

The system according to the invention maintains a collection 221 of preference profiles. When the user indicates his like or dislike for the program 201, the next step 220 is to determine for each preference profile from said collection a score for the program 201. This score must indicate the degree of agreement of the program 201 with each of said preference profiles. There are many ways in which this score can be computed.

The score can be computed, for instance, by comparing attribute values of metadata associated with the particular program 201 with attribute values stored in each of said preference profiles. An attribute value having a positive rating in the preference profile which is also present in the metadata contributes positively to this score for the program, and similarly a negatively rated attribute value in the preference profile contributes negatively to the score.

The table below presents an illustrative, non-limiting example of attribute/value pairs for a television program. Such an attribute/value pair is also referred to as a property of the program.

| | |
|---|---|
| Title | The Enemy |
| Category | Movie |
| Category | Drama |
| Duration | 98 minutes |
| Director | Tom Kinninmont |
| Release year | 2001 |
| Rating | TV-MA |
| Actor | Tom Conti |
| Actor | Roger Moore |
| Actor | Luke Perry |
| Actor | Olivia d'Abo |
| Description | An inventor's deadly biological weapon is in danger of |
| | falling into the wrong hands. |
| Channel | HBO |
| Date | Feb. 15, 2001 |
| Time | 9:00 PM |

A preference profile can be expressed as a collection of rated properties. A rated property is a pair of a property p and a rating r. Formally, a preference profile P can be expressed as P={(p₁,r₁), (p₂,r₂), . . . ,(pₙ,rₙ)}. A program has a set of properties Q={p₁,p₂, . . . ,pₙ}. If property pi in Q is equal to property pⱼ of a rated property (pⱼ,rⱼ) in P, then rⱼ contributes to the computation of the matching degree of the program with properties Q and the preference profile P. For example, all ratings rⱼ of properties in P that are equal to properties in Q may be summed to obtain a score for the program.

In another embodiment, a rating may be a composite data element, for example representing both implicit and explicit preference recordings. Co-pending U.S. patent application Ser. No. 09/666401 (Attorney Docket PHUS000239) by the same applicant as the present application describes a television programming recommender that generates television program recommendations based on a combined implicit/explicit program recommendation score. The disclosed television programming recommender combines the explicit viewing preferences of viewers with their television viewing behavior (implicit preferences) to generate program recommendations.

Explicit viewing preferences can be obtained by having viewers rate their preferences for various program attributes. The explicit viewing preferences are then utilized to generate an explicit recommendation score, E, for an upcoming television program. Implicit viewing preferences can be obtained by monitoring a user's viewing history and analyzing the programs that are actually watched by a user (positive examples) and the shows that are not watched by the user (negative examples). The implicit viewing preferences are then utilized to generate an implicit recommendation score, I, for an upcoming television program. A combined recommendation score, C, is computed based on the explicit and implicit scores, E and I. In one implementation, the combined recommendation score, C, can be computed using a weighted linear mapping.

In another embodiment, a Bayesian classifier is used to compute the probability that the program 201 matches a particular profile. Such a technique is described in co-pending U.S. patent application Ser. No. 09/498271 (Attorney Docket PHUS000018) to the same applicant as the present application.

Co-pending U.S. patent application Ser. No. 09/466406 (Attorney Docket PHA 23902) to the same applicant as the present application describes another technique, which utilizes inductive principles to identify a set of recommended programs that may be of interest to a particular viewer, based on past viewing behavior. A user's viewing history is monitored and the shows that are actually watched by a user (positive examples) and the shows that are not watched by the user (negative examples) are analyzed.

For each positive and negative program example (i.e., programs watched and not watched), a number of program attributes are classified in the user profile. The various attributes are then positioned in a hierarchical decision tree based on a ranking of the entropy of each attribute. Each node and sub-node in the decision tree corresponds to a given attribute from the user profile. Each leaf node in the decision tree corresponds to either a positive or negative recommendation for a program mounted at the corresponding leaf node. The decision tree is built using a decision tree process that implements a “top-down divide and conquer” approach. The probability that the program 201 matches a particular profile can be regarded as the score for that program 201 given that particular profile. Because the scores are then expressed as probabilities, they can be easily compared. Other ways to compute a score known in the art can of course also be used.

Once a score for the program 201 has been determined for each preference profile, a determination 203 need to be made whether the input represents a positive or a negative user preference. If the received input at 210 is a simple good/bad input, such as the input from the “thumbs up” and “thumbs down” buttons 211, 212, then this determination is trivial. However, the received input may also be a numeric value, for example a number chosen from a range from 1 to 10 or 1 to 5 or something similar. In that case, the received input is deemed to represent a positive user preference if the numeric value in question exceeds a threshold value, and is deemed to represent a negative user preference otherwise. For example, if the rating is a numeric value ranging from 1 to 10, with 1 being the lowest rating and 10 being the highest rating, then the threshold value could be chosen at 5.5, and then any rating of 6 and higher would be deemed to represent a positive user preference, and a rating of 5 and lower would be deemed to represent a negative user preference.

The received input could also be chosen from a limited set of predefined opinions, such as “very bad”, “bad”, “neutral”, “good”, and “very good”. In such a case, it is possible to simply define in advance which of these values are to be considered as a positive user preference and which are to be considered as a negative user preference. The values could also be assigned a corresponding numerical value, in which case they can be subsequently handled as described in the preceding paragraph. Of course, other rating ranges are also easily conceivable.

If the input received at 210 is determined to represent a positive user preference, then at 240 a preference profile is selected from the collection 221 which has a relatively high score with respect to the scores of all the preference profiles from said collection 221. Preferably, this relatively high score is a maximum of the scores of all the preference profiles from said collection 221. If there are plural preference profiles that all have the same relatively high score with respect to the scores of all the preference profiles, then all these plural preference profiles are selected. The selected preference profile(s) are then updated to reflect the positive user preference for the program 201.

Similarly, if the input represents a negative user preference, then at 245 a preference profile from said collection 221 having a relatively low score with respect to the scores of all the preference profiles from said collection 221 is selected. If plural preference profiles from said collection 221 have the same relatively low score with respect to the scores of all the preference profiles, then all said plural preference profiles are selected. The selected preference profile(s) are then updated to reflect the negative user preference for the program 201. Updating a preference profile can be as simple as adding an identifier for the program 201 and the received rating to the preference profile. The rating could also be related to a property of the program 201, such as its program category, in which case the corresponding property in the preference profile should be updated. In general, updating a preference profile to reflect a rating is conventional in the art and should be readily apparent.

In case the received input represents a numeric value, the preference profile(s) in question should be additionally updated to reflect this numeric value.

After the selected preference profiles have been updated, at 250 the program 201 can be added to the personal channel(s) corresponding to the selected preference profile(s). This will be explained in more detail with reference to FIG. 3 below.

Finally, at 260, the method is completed. The method may then return to step 200 in order to process further input representing further user preferences for further programs.

FIG. 3 schematically illustrates the concept of personal channel. It is possible, using a preference profile from said collection 221, to filter and select a subset of all the programs presently available into a separate channel, called a “personal channel”. This personal channel can then be made available to the user in the same fashion as ordinary channels are available. The creation and maintenance of the personal channel is effected by the above-mentioned personal channel module 15. When the user switches to the personal channel, the personal channel module 15 arranges for the correct programs to be displayed on the display 9. The reader is referred to the previously mentioned International Patent Application WO 00/40012 for detailed information on implementing personal channels.

Each preference profile from the collection 221 can be assigned its own personal channel. This results in there being available a personal science fiction channel, a personal sports channel and a personal soap channel, for example. The user can then simply select the appropriate personal channel to view the programs he likes. This is a very simple and effective way of accessing programs that match a particular profile. The user already knows how to navigate between channels on his television, and so will have no difficulty in navigating to and between personal channels.

In the channel overview 300 in FIG. 3, there are shown 4 “ordinary” channels CH1, CH2, CH3 and CH4, and 3 personal channels PCH1, PCH2 and PCH3. Each of the personal channels PCH1, PCH2, PCH3 corresponds to a preference profile from the collection 221 as shown in FIG. 3. When the user uses his remote control to navigate from one channel to another, he will come across both the ordinary channels and the personal channels. This way, the programs made available through the filtering effected by the personal profiles from the collection 221 are made available in the same way as the programs in the ordinary channels.

It may be desirable to add the program 201 which was rated at step 210 as described above to the personal channel corresponding to the preference profile having the relatively high score. The user can rate programs while navigating through the EPG, during which he may encounter a program that is scheduled for presentation in the near future. If the user likes the program, he can immediately give it a rating. Using the method as described with reference to FIG. 2, this rating is then incorporated into a suitable preference profile. The program 201 should then also be added to the personal channel corresponding to that preference profile. This way the user can rate any programs he sees at any time, and view then in the appropriate personal channel.

If the program which the user rated is part of a series, then all future episodes of the series might also be added to the personal channel, because apparently the user like the series and of course, if the program 201 was found to be suitable for plural preference profiles, then the program should be added to the personal channels corresponding to each of those plural preference profiles.

The system according to the invention can, in addition to a television receiver, be realized as a set-top box or a (digital) video recorder. The system can also be realized as a computer program product being arranged for causing a processor to execute the steps described with reference to FIG. 2. The computer program product enables a programmable device to function as the system according to the invention.

1. A method of registering a user preference for a program (201) in at least one of a collection (221) of preference profiles for recording a set of user preferences, comprising
receiving (210) an input (211, 212) representing the user preference for the program (201),
determining (220) for each preference profile from said collection (221) a score for the program (201), said score indicating the degree of agreement of the program (201) with said preference profile,
if the input (211, 212) represents a positive user preference, updating (240) a preference profile from said collection (221) having a relatively high score with respect to the scores of all the preference profiles from said collection (221) to reflect the positive user preference for the program (201), and
if the input (211, 212) represents a negative user preference, updating (245) a preference profile from said collection (221) having a relatively low score with respect to the scores of all the preference profiles from said collection (221) to reflect the negative user preference for the program (201).

2. The method as claimed in claim 1, whereby said relatively high score is a maximum of the scores of all the preference profiles from said collection (221), and said relatively low score is a minimum of the scores of all the preference profiles from said collection (221).

3. The method as claimed in claim 1, whereby the received input (211, 212) is a numeric value, which is deemed to represent a positive user preference if the numeric value exceeds a threshold value, and which is deemed to represent a negative user preference otherwise.

4. The method as claimed in claim 3, where the preference profile is additionally updated to reflect the numeric value of the user preference.

5. The method as claimed in claim 1, whereby if plural preference profiles from said collection (221) have the same relatively high score with respect to the scores of all the preference profiles from said collection (221), all said plural preference profiles are updated to reflect the positive user preference for the program (201).

6. The method as claimed in claim 1, whereby if plural preference profiles from said collection (221) have the same relatively low score with respect to the scores of all the preference profiles from said collection (221), all said plural preference profiles are updated to reflect the negative user preference for the program (201).

7. The method as claimed in claim 1, further comprising maintaining, for each preference profile from said collection (221), a personal channel for reproducing program (201)s that match the preference profile to which the personal channel corresponds, and adding (250) the program (201) to the personal channel corresponding to the preference profile from said collection (221) having the relatively high score.

8. A system for registering a user preference for a program (201) in at least one of a collection (221) of preference profiles for recording a set of user preferences, comprising
receiving means (10) for receiving an input (211, 212) representing the user preference for the program (201),
scoring means (14) for determining for each preference profile from said collection (221) a score for the program (201), said score indicating the degree of agreement of the program (201) with said preference profile,
updating means for determining if the input (211, 212) represents a positive user preference, and if so updating a preference profile from said collection (221) having a relatively high score with respect to the scores of all the preference profiles from said collection (221) to reflect the positive user preference for the program (201), and if the input (211, 212) represents a negative user preference, updating a preference profile from said collection (221) having a relatively low score with respect to the scores of all the preference profiles from said collection (221) to reflect the negative user preference for the program (201).

9. The system as claimed in claim 8, further comprising personal channel means (15) for maintaining, for each preference profile from said collection (221), a personal channel for reproducing program (201)s that match the preference profile to which the personal channel corresponds, and adding the program (201) to the personal channel corresponding to the preference profile from said collection (221) having the relatively high score.

10. The system as claimed in claim 8, further comprising a display (9) for rendering the program (201).

11. A computer program product enabling a programmable device to function as a system as claimed in claim 8.
